(19) United States
(12) Patent Application Publication
(10) Pub. No.: US 2024/0137841 A1
(43) Pub. Date: Apr. 25, 2024

(54) COMMUNICATION DEVICE, METHOD FOR CONTROLLING COMMUNICATION DEVICE, AND NON-TRANSITORY COMPUTER-READABLE STORAGE MEDIUM

(71) Applicant: CANON KABUSHIKI KAISHA, Tokyo (JP)

(72) Inventor: DAISUKE HORIO, Kanagawa (JP)

(21) Appl. No.: 18/493,603

(22) Filed: Oct. 23, 2023

Related U.S. Application Data
(63) Continuation of application No. PCT/JP2022/014826, filed on Mar. 28, 2022.

(30) Foreign Application Priority Data
Apr. 25, 2021 (JP) 2021-074410

(51) Int. Cl. H04W 40/24; H04W 48/18; H04W 88/08

(52) U.S. Cl. CPC H04W 40/248; H04W 48/18; H04W 88/08

(57) ABSTRACT

A communication device functioning as a base station in a communication network comprises: receiving means for receiving, from a node that relays communication between the communication device and a user equipment, first information regarding a path between the node and the communication device and second information regarding a status of the node; determining means for determining a type of network slice supported by the node, based on the first information and the second information; and informing means for informing the node of the determined type of network slice.

### CROSS-REFERENCE TO RELATED APPLICATIONS

This application is a Continuation of International Patent Application No. PCT/JP 2022/014826, filed Mar. 28, 2022, which claims the benefit of Japanese Patent Application No. 2021-074410, filed Apr. 26, 2021, both of which are hereby incorporated by reference herein in their entirety.

### BACKGROUND OF THE INVENTION

### Field of the Invention

The present invention relates to a communication device, a method for controlling a communication device, and a non-transitory computer-readable storage medium.

### Background Art

IAB (Integrated Access and Backhaul) has been standardized as backhaul communication technology in 3GPP (3rd Generation Partnership Project). With IAB technology, 28 GHz millimeter-wave wireless communication and the like used for access communication between base stations and user equipments (UEs) are utilized as backhaul communication simultaneously (PTL1). Use of the IAB technology makes it possible to expand the area coverage at a lower cost, compared to wired communication using conventional optical fibers, and thus it is expected that the IAB technology is effective in constructing next-generation public networks.

In backhaul communications using IAB technology, a relay device called an IAB node relays communications from IAB donors, which are equivalent to conventional base stations, using millimeter wave communications. Furthermore, an IAB node can expand an area by forming bearers between the IAB node and other multiple IAB nodes, and forming a network tree (IAB network) starting from an IAB donor. IAB nodes serving as extension means for expanding the area of an IAB donor can be controlled via BAP (Backhaul Adaptation Protocol), which is the routing protocol for IAB.

On the other hand, in next-generation public networks, the introduction of the concept of network slicing, which virtually provides network slices that meet the requirements of multiple different services on a shared network, is being studied. eMBB (enhanced Mobile Broadband), which is high-speed and large-capacity communication, URLLC (Ultra-Reliable and Low Latency Communications), which are low latency communications, and MIot (Massive Internet of Things), which is simultaneous multiple connection, have been already specified as types of network slices.

PTL2 discloses a method in which UE can receive a desired service as a result of the UE transmitting a network slice request to a base station, and the base station responding whether or not the base station supports the network slice, for example. A mechanism, which allows the UE to select a network slice provided by the base station according to a purpose and makes the network slice available in this manner, has been studied.

### CITATION LIST

### Patent Literature

PTL1: Japanese Patent Laid-Open No. 2019-534625
PTL2: Japanese Patent Laid-Open No. 2020-511863

The operation of network slices in communication networks such as IAB networks is not clearly specified in BAP (Backhaul Adaptation Protocol). Therefore, in the case of the IAB network, the IAB nodes directly notify lower IAB nodes and UE of NSSAI (Network Slice Selection Assistance Information) received from an IAB donor connected. Note that NSSAI is information that includes SSTs (Slice/Service types), which indicate the types of network slices that can be supported, in a list form.

In such operation, an IAB node far away from an IAB donor can only make a notification of the same NSSAI as that of the IAB donor even when it does not have a configuration to support network slices supported by the IAB donor, for example. As a result, UE that receives the notification of NSSAI may not be able to provide the desired quality even when the UE selects and requests a desirable network slice.

The present invention has been achieved in view of the above-described issues, and it is an object of the present invention to appropriately determine and transmit information regarding a network slice that can be supported by a node.

### SUMMARY OF THE INVENTION

A communication device according to the present invention has the following configuration as means for achieving the object. That is, a communication device functions as a base station in a communication network. The communication device includes: receiving unit configured to receive, from a node that relays communication between the communication device and a user equipment, first information regarding a path between the node and the communication device and second information regarding a status of the node; determining unit configured to determine a type of network slice supported by the node, based on the first information and the second information; and informing unit configured to inform the node of the determined type of network slice.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram showing an example of a backhaul communication system.

FIG. 2 is a block diagram showing an example of a hardware configuration of an IAB donor.

FIG. 3 is a block diagram showing an example of a software functional configuration of an IAB donor.

FIG. 4A is a flowchart showing processing for determining a slice type of IAB node according to an embodiment.

FIG. 4B is a flowchart showing processing for determining a slice type of IAB node according to an embodiment.

FIG. 5 shows an example of a conceptual diagram of NSSAI information elements.

FIG. 6A is a diagram showing a communication sequence in a communication system according to an embodiment.

FIG. 6B is a diagram showing a communication sequence in a communication system according to an embodiment.

FIG. 7 is a diagram showing a network topology after a slice type is determined according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### Embodiment 1

### Configuration of Communication System

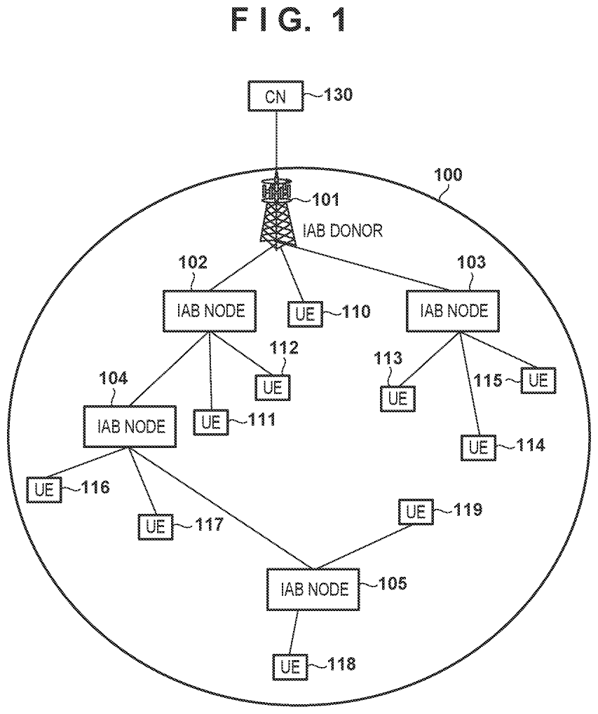

FIG. 1 is a diagram showing an example of a backhaul communication system (“communication system” hereinafter) according to Embodiment 1. A communication network using the backhaul communication may include an NR (New Radio) backhaul link and an NR access link. An IAB (Integrated Access and Backhaul) donor 101 that provides connection to a Core Network (CN) 130 is present in a communication system 100. The IAB donor 101 forms an IAB network (communication network) constituted by the IAB donor 101 and IAB nodes 102 to 105. Each IAB donor can function as a wireless base station device in the communication network. The IAB node may also function as a wireless base station device.

The IAB donor 101 performs overall control of the IAB nodes 102 to 105, and forms an area covered by the IAB donor 101. UEs 110 to 119 are connected to an IAB donor or IAB node in order to perform communication according to desired applications. As shown in FIG. 1, in the initial state, the UEs 110 to 119 connect to the IAB donor 101 or the IAB nodes 102 to 105, which have the highest radio wave intensity therefor. Note that examples of the intensity of radio waves include RSRP (Reference Signal Received Power) values and RSCP (Received Signal Code Power) values.

At the initial stage of the construction of an IAB network, the type of network slice (SST (slice/service type), which will be simply referred to as a “slice type” hereinafter) that can be supported by the IAB nodes 102 to 105 has not yet been determined. A slice type that can be supported by the IAB nodes 102 to 105 is determined by the IAB donor 101 that performs overall control of the communication system 100, and the IAB nodes 102 to 105 are informed of the slice type.

The IAB donor 101 and the IAB nodes 102 to 105 notify the UEs 110 to 119 of the determined slice type together with cell IDs (identifiers) that correspond to the IAB donor 101/IAB nodes 102 to 105. Note that notification is given of information together with the slice type, and such information is not limited to the cell IDs and need only be information with which the IAB donor 101/IAB nodes 102 to 105, which inform UEs of the slice type, can be specified (can be identified).

The UEs 110 to 119 can judge, based on the received slice type/cell ID, whether or not a slice type to be used according to an application to be executed is supported by the IAB donor 101 or the IAB nodes 102 to 105, and establish or change connection. Alternatively, the UEs 110 to 119 may request a slice type to be used from the IAB donor 101 and the IAB nodes 102 to 105, and may establish or change connection based on a response to the request.

Configurations of IAB Donor/IAB Node

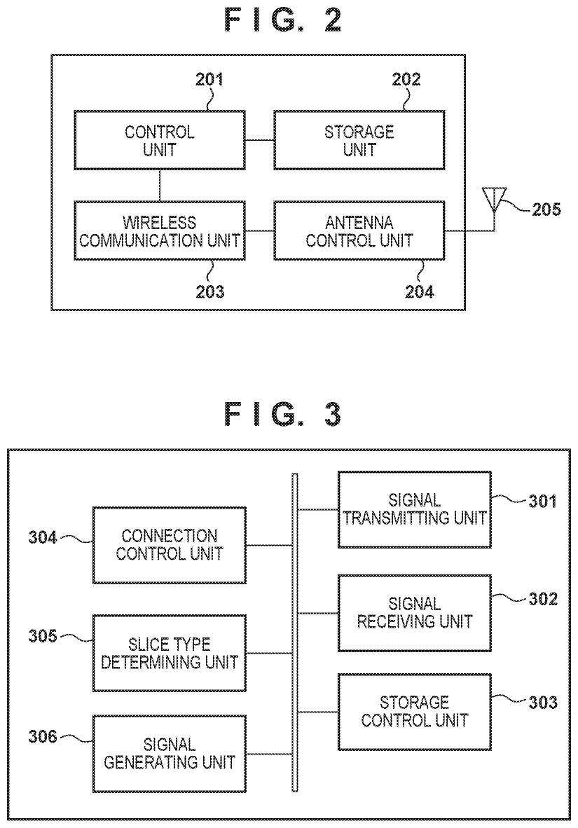

Next, configurations of the IAB donor 101 and the IAB nodes 102 to 105 will be described. FIG. 2 is a block diagram showing an example of a hardware configuration of the IAB donor 101. Although a hardware configuration will be described assuming the IAB donor 101 here, the IAB nodes 102 to 105 can also have a hardware configuration similar to that in FIG. 2.

As an example of a hardware configuration, the IAB donor 101 includes a control unit 201, a storage unit 202, a wireless communication unit 203, an antenna control unit 204, and an antenna 205. The control unit 201 performs overall control of the entire device by executing a control program stored in the storage unit 202. The control unit 201 is constituted by one or more CPUs (Central Processing Units) or MPUs (Micro Processing Units), for example.

The storage unit 202 is constituted by a ROM (Read Only Memory), RAM (Random Access Memory), or the like. The storage unit 202 stores various types of information such as a control program executed by the control unit 201 and information regarding a cell ID or UE to be connected, and path information of the IAB nodes under control (IAB nodes 102 to 105 in FIG. 1). Also, the storage unit 202 may store information regarding network slices (slice types) supported by the IAB donor 101. Various operations, which will be described later, may be performed by the control unit 201 executing the control program stored in the storage unit 202.

The wireless communication unit 203 is a wireless communication unit for performing cellular network communication such as LTE (Long Term Evolution) and 5G (5th Generation) conforming to the 3GPP (3rd Generation Partnership Project) standards. The antenna control unit 204 controls the antenna 205 used for wireless communication executed in the wireless communication unit 203. The antenna 205 may include a plurality of antennas.

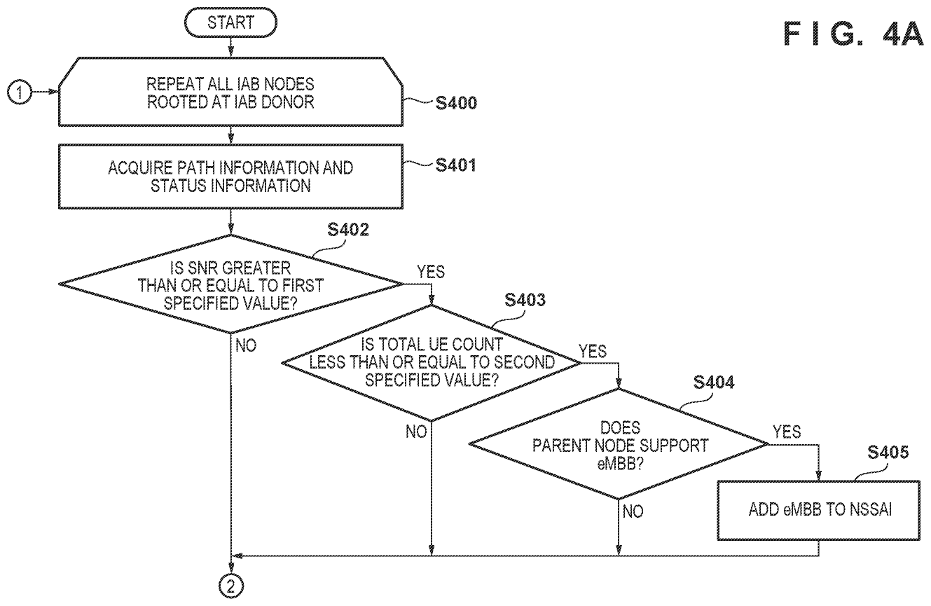

FIG. 3 is a block diagram showing an example of a software functional configuration of the IAB donor 101 according to this embodiment. As an example of a software functional configuration, the IAB donor 101 includes a signal transmitting unit 301, a signal receiving unit 302, a storage control unit 303, a connection control unit 304, a slice type determining unit 305, and a signal generating unit 306. A software functional configuration will be described assuming the IAB donor 101, and the IAB nodes 102 to 105 will be described later.

The signal transmitting unit 301 and the signal receiving unit 302 control the wireless communication unit 203 and the antenna control unit 204 via the control unit 201, and execute cellular network communication (transmission and reception respectively), such as LTE and 5G conforming to the 3GPP standards, with other communication devices (the IAB nodes or UEs). The storage control unit 303 controls (stores/reads out etc.) and manages various data stored in the storage unit 202. The connection control unit 304 controls connection to other communication devices through communication via the signal transmitting unit 301 and the signal receiving unit 302, for example.

The slice type determining unit 305 determines the slice types of IAB nodes 102 to 105 based on path information and status information received (acquired) from the IAB nodes 102 to 105 via the signal receiving unit 302. In this embodiment, the slice type determining unit 305 acquires path information and status information from the IAB nodes 102 to 105, and determines the slice types of IAB nodes 102 to 105. In this embodiment, the path information may refer to (include) information regarding the number of hops from the IAB donor 101 to each of the IAB nodes 102 to 105, and information regarding routing in the IAB nodes 102 to 105. Also, the status information may refer to (include) information regarding SNR (Signal to Noise Ratio) values as the received signal quality, and the number of UEs connected, and specification information (whether or not TSN (Time-Sensitive Networking) is supported), and the like of the IAB nodes 102 to 105. TSN is network technology that enables the realization of interoperability between IT networks and industrial networks that extend standard Ethernet. Note that, although SNR is used in this embodiment, other information indicating received signal quality may be used instead of SNR.

The signal generating unit 306 generates packets (signals) for informing/notifying the IAB nodes 102 to 105 and the UEs 110 to 119 of various types of information. The signal generating unit 306 in the IAB donor 101 generates two types of packets.

The signal generating unit 306 generate, as a first type of packet, a control packet for informing the IAB nodes 102 to 105 of the slice type determined by the slice type determining unit 305. In this embodiment, the IAB nodes are informed of the slice type using a control packet according to the BAP (Backhaul Adaptation Protocol). However, there is no limitation thereto, and other control packets may be used. In a case where the IAB nodes 102 to 105 can interpret the RRC (Radio Resource Control) protocol, for example, the IAB nodes 102 to 105 may be informed by the control packet according to the RRC protocol or a protocol of a communication layer above the RRC layer in the protocol hierarchy.

The signal generating unit 306 generates, as a second type of packet, a notification packet for notifying the UEs 110 to 119 of the cell ID with which the IAB donor 101 can be identified, together with the slice type determined by the slice type determining unit 305.

Next, a software functional configuration of the IAB nodes 102 to 105 according to this embodiment will be described below. The software functional configuration of the IAB nodes 102 to 105 may be similar to the software configuration of the IAB donor 101 described with reference to FIG. 3. However, other communication devices (IAB nodes and UEs) are read as other devices (IAB donor and UEs) in the above description regarding to FIG. 3. Also, the IAB nodes 102 to 105 have no slice type determining unit 305, and the signal generating unit 306 does not generate the first type of packet. The signal generating unit 306 generates a notification packet for notifying the UEs 110 to 119 of the cell IDs with which the IAB nodes 102 to 105 can be identified, together with the slice type of which the IAB donor 101 has informed. The connection control unit 304 can perform control for link connection/release to/from UE.

Slice Type Determination Procedure Performed by IAB Donor

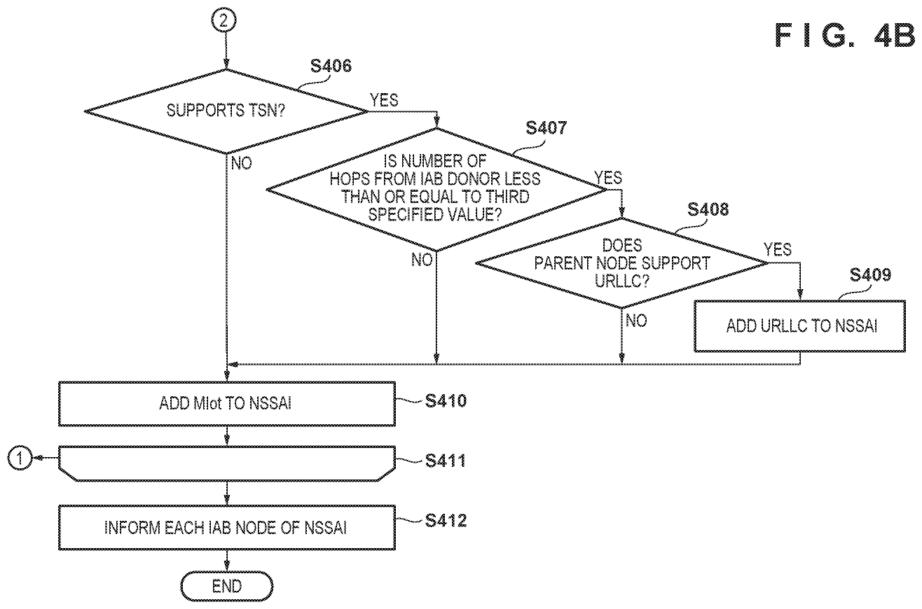

FIGS. 4A and 4B are flowcharts showing processing for determining the slice type of an IAB node by IAB according to this embodiment. Note that it is presumed that the IAB donor 101 supports all of the slice types: high-speed and large-capacity (eMBB (enhanced Mobile Broadband)), low latency (URLLC (Ultra-Reliable and Low Latency Communications)), and simultaneous multiple connection (MIot (Massive Internet of Things)). Information regarding the supported slice types can be stored in the storage unit 202. Also, it is presumed that the IAB nodes 102 to 105 can support MIot in this embodiment.

The processing from step S400 to step S411 is repeated in order to determine slice types of all IAB nodes 102 to 105 rooted at the IAB donor 101. It is presumed that, in this embodiment, as a non-limiting example, the IAB donor determines slice types in the ascending order of the number of hops from the IAB donor 101. Note that it is presumed that the number of hops from the IAB donor 101 to the IAB node 102 and the number of hops from the IAB donor 101 to the IAB node 103 are the same, but the IAB donor 101 determines slice types in the order of the IAB nodes 102, 103, 104, and 105. A target IAB node for determining the slice type in one loop from step S400 to step S411 is referred to as a “target IAB node”.

After the connection control unit 304 establishes connection to the target IAB node, the slice type determining unit 305 acquires path information and status information regarding the target IAB node in step S401. Note that the slice type determining unit 305 may collect information regarding all of the IAB nodes 102 to 105 in advance outside the loop from step S400 to step S411.

The processing from step S402 to step S405 is processing for judging whether the target IAB node supports high-speed and large-capacity communication (eMBB in this embodiment) as a slice type. In step S402, the slice type determining unit 305 judges whether the SNR value included in the status information acquired from the target IAB node is greater than or equal to a first specified value. The SNR may be SNR between the target IAB node and a node (parent node) connected upstream to the target IAB node. The first specified value used here is a value set in advance to satisfy the communication speed (data rate) at which eMBB communication is possible. In a case where the SNR value is greater than or equal to the first specified value (Yes in step S402), the processing proceeds to step S403, and in a case where the SNR value is not greater than or equal to the first specified value (No in step S402), the processing proceeds to step S406.

In step S403, the slice type determining unit 305 judges whether or not the total number of UEs connected between the IAB donor 101 and the target IAB node (the total number of connected UEs at the IAB donor 101 and the target IAB node) is less than or equal to a second specified value. In the communication system 100 shown in FIG. 1, in a case where the target IAB node is the IAB node 102, the total number of connected UEs is 3, and in a case where the target IAB node is the IAB node 104, the total number of connected UEs is 5. The second specified value is 4 in this embodiment, but may be another value. In a case where the total number of connected UEs is less than or equal to the second specified value (Yes in step S403), the processing proceeds to step S404, and in a case where the total number of connected UEs is not less than or equal to the second specified value (No in step S403), the processing proceeds to step S406.

In step S404, the slice type determining unit 305 judges, based on the acquired status information or information stored in the storage unit 202, whether or not a node (parent node) connected upstream to the target IAB node supports eMBB. In a case where the target IAB node is the IAB node 102, the parent node is the IAB donor 101, and in a case where the target IAB node is the IAB node 104, the parent node is the IAB node 102. That is, the parent node may be the IAB donor 101 or another IAB node that is different from the target IAB node, which is directly connected to the target IAB node between the target IAB node and the IAB donor 101. In a case where the parent node supports eMBB (Yes in step S404), the processing proceeds to step S405, and in a case where the parent node does not support eMBB (No in step S404), the processing proceeds to step S406.

In step S405, the signal generating unit 306 adds eMBB to NSSAI (Network Slice Selection Assistance Information). As described above, NSSAI is information including slice types (SSTs (Slice Service Types)) that can be supported in a list form. Specifically, the signal generating unit 306 sets an SST value corresponding to eMBB to the NSSAI information element.

The processing from step S406 to step S409 is processing for judging whether or not the target IAB node supports low latency communication (URLLC in this embodiment) as a slice type. In step S406, the slice type determining unit 305 judges, based on the status information acquired from the target IAB node, whether or not the target IAB node supports TSN (Time-Sensitive Networking). In a case where the target IAB node supports TSN (Yes in step S406), the processing proceeds to step S407, and in a case where the target IAB node does not support TSN (No in step S406), the processing proceeds to step S410.

In step S407, the slice type determining unit 305 judges, based on the path information acquired from the target IAB node, whether or not the number of hops from the IAB donor 101 to the target IAB node is less than or equal to a third specified value. In a case where the target IAB node is the IAB node 102, the number of hops is 1. The following description will be given assuming that the third specified value is 2 in this embodiment. In a case where the number of hops is less than or equal to the third specified value (Yes in step S407), the processing proceeds to step S408, and in a case where the number of hops is not less than or equal to the third specified value (No in step S407), the processing proceeds to step S410. In step S408, the slice type determining unit 305 judges, based on the acquired status information or information stored in the storage unit 202, whether or not a parent node supports URLLC. Although the targets for judging support are different from each other, the processing of step S408 is the same as that of step S404. In a case where the parent node supports URLLC (Yes in step S408), the processing proceeds to step S409, and in a case where the parent node does not support URLLC (No in step S408), the processing proceeds to step S410. In step S409, the signal generating unit 306 adds URLLC to NSSAI. Specifically, the signal generating unit 306 sets an SST value corresponding to URLLC to the NSSAI information element. In the subsequent step S410, the signal generating unit 306 sets an SST value corresponding to MIot to the NSSAI information element.

The processing from step S400 to step S411 is performed on all the target IAB nodes in the order of IAB nodes 102, 103, 104, and 105, and then the signal generating unit 306 generates BAP control packets that include the set (generated) NSSAI information element to the IAB nodes 102 to 105. Then, in step S412, the signal transmitting unit 301 informs the IAB nodes 102 to 105 of NSSAI (slice type list) by transmitting the generated BAP control packets to the IAB nodes 102 to 105.

As described above, the IAB donor 101 can determine slice types for the IAB nodes 102 to 105 in consideration of the path information and the status information. That is, the IAB donor 101 can assign slice types respectively to the IAB nodes according to a communication state and topology.

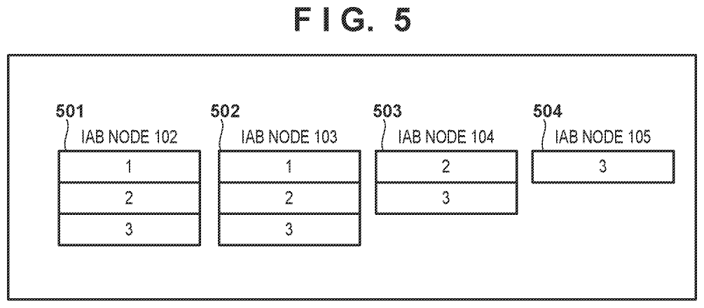

FIG. 5 shows an example of a conceptual diagram of NSSAI information elements showing the slice types of the IAB nodes 102 to 105 determined through the processing shown in FIGS. 4A and 4B. NSSAI 501 to NSSAI 504 respectively represent conceptual diagrams of NSSAI information elements for the IAB nodes 102 to 105 determined by the IAB donor 101. In the example shown in FIG. 5, the SST value corresponding to eMBB is set to “1”, the SST value corresponding to URLLC is set to “2”, and the SST value corresponding to MIot is set to “3”. It can be seen from FIG. 5 that the IAB nodes 102 and 103 support eMBB, URLLC, and MIot, the IAB node 104 supports URLLC and MIot, and the IAB node 105 supports only MIot. Note that FIG. 5 shows an example in which SST values corresponding to three types of slice types can be set. However, by adding other SST/SST values, slice types can be defined and provided according to other services and purposes.

Operations in Communication System

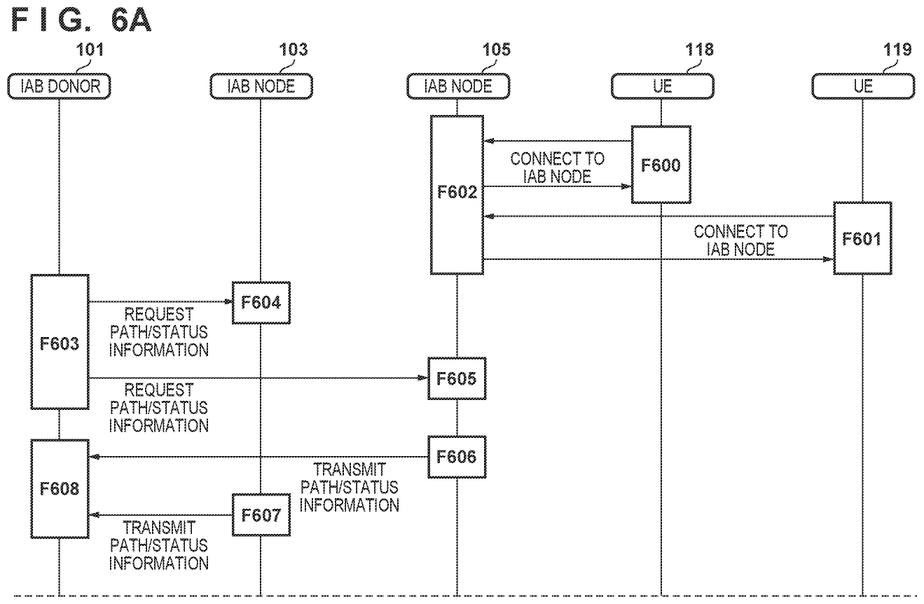

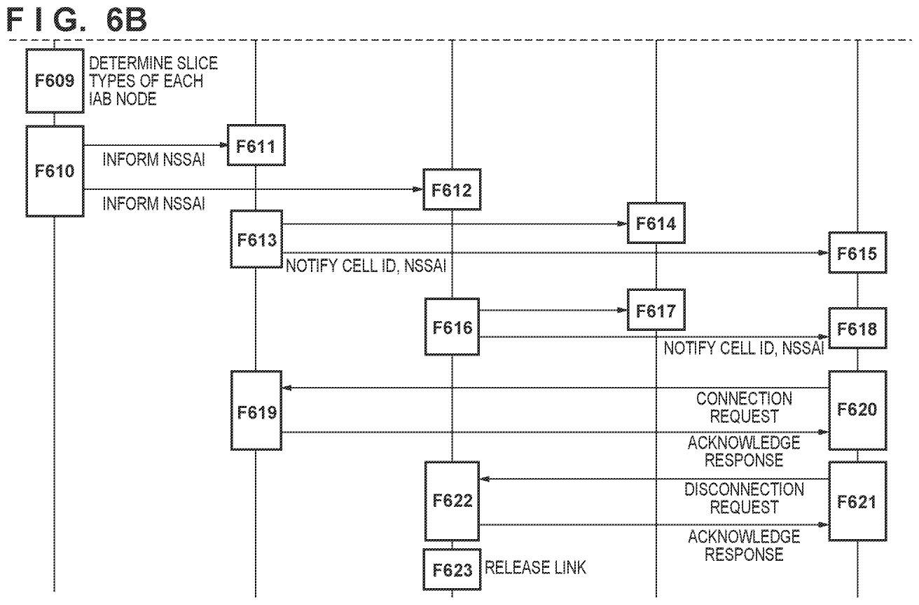

FIGS. 6A and 6B are diagrams showing a communication sequence in the communication system 100 according to this embodiment. The following describes operations performed from when the IAB donor 101 determines slice types that can be supported by the IAB nodes 103 and 105 and informs the UEs 118 and 119 of the slice types, to when the UEs 118 and 119 connect to IAB nodes that support desired slice types. Note that the same processing is performed on the other IAB nodes 102 and 104, and the UEs 110 to 117, but for the sake of simplifying a description, only the above communication device will be described.

As the initial state of the communication system 100 described in FIG. 1, the UEs 118 and 119 make a connection request to the IAB node 105 with the highest radio wave intensity in F600 and F601. In F602, the IAB node 105 acknowledges the connection requests transmitted from the UEs 118 and 119, and processing for connection between the IAB node and the UEs 118 and 119 is performed. It is presumed that the UE 119 desires to receive eMBB service provision according to the application to be executed.

In F603 to F605, the IAB donor 101 requests the transmission of the path information and the status information from the IAB node 103 and 105, and the IAB nodes 103 and 105 receive the request. In F606, the IAB node 105 transmits, to the IAB donor 101, the path information and the status information regarding the IAB node 105. In F607, the IAB node 103 transmits, to the IAB donor 101, the path information and the status information regarding the IAB node 103 in a similar manner. In F608, the IAB donor 101 receives the path information and the status information from the IAB nodes 103 and 105. Here, the IAB donor 101 may collect (receive) the path information and the status information regarding the IAB nodes 103 and 105 at certain periodical timing. Alternatively, the IAB nodes 103 and 105 may spontaneously transmit the information to the IAB donor 101 when the communication state changes.

In F609, the IAB donor 101 performs the processing of flowcharts shown in FIGS. 4A and 4B, and determines slice types supported by the IAB nodes 103 and 105. The determined slice types are shown in FIG. 5, and the IAB node 103 supports all the slice types (eMBB, URLLC, MIot), and the IAB node 105 supports only MIot.

In F610 and F611, the IAB donor 101 informs the IAB node 103 of NSSAI indicating the slice type determined for the IAB node 103, and the IAB node 103 receives the NSSAI. In F610 and F612, similarly, the IAB donor 101 informs the IAB node 105 of NSSAI indicating the slice type determined for the IAB node 105, and the IAB node 105 receives the NSSAI.

In F613 to F615, the IAB node 103 notifies the UEs 118 and 119 of the NSSAI of which the IAB donor 101 has informed in F611, together with the cell ID with which the IAB node 103 can be identified, and the UEs 118 and 119 receive them. In F616 to F618, the IAB node 105 notifies the UEs 118 and 119 of the NSSAI of which the IAB donor 101 has informed in F612, together with the cell ID with which the IAB node 105 can be identified, and the UEs 118 and 119 receive them.

As described above, the UE 119 desires to receive eMBB service provision. In view of this, in F619 and F620, the UE 119 makes a connection request to the IAB node 103 that supports eMBB, the IAB node 103 repeats a connection acknowledge response, and thus the UE 119 is connected to the IAB node 103. Here, in a case where the UE 119 is connected to the IAB node 103, the total number of connected UEs in the IAB node 103 changes from 3 to 4. As described above, the second specified value (step S403 in FIG. 4A) used to judge whether the IAB node supports eMBB is 4 in this embodiment, and thus it can be judged that the IAB node 103 can maintain eMBB, and the acknowledge response is sent to the UE 119. Also, in a case where the total number of UEs connected to the IAB node 103 increases, the IAB node 103 may make an inquiry about the reassignment of NSSAI to the IAB donor 101 again, the NSSAI may be updated, and it may be judged whether the UE 119 can be connected thereto.

In F622 and F623, the UE 119 transmits a disconnection request to the IAB node 105, and the IAB node 105 returns a disconnection acknowledge response and releases the link with the UE 119.

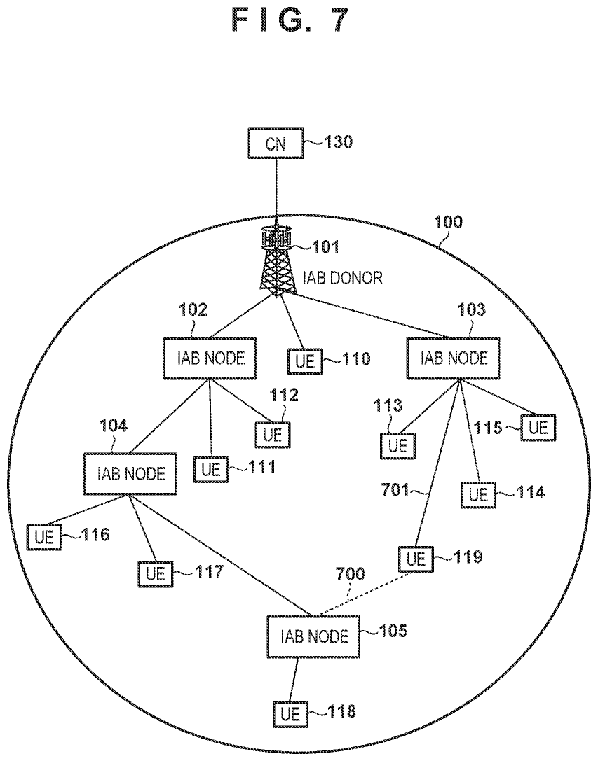

FIG. 7 is a diagram showing a network topology after a slice type is determined by the IAB donor 101 in the communication system 100 according to an embodiment. In the communication system 100, the UE 119, which is connected to the IAB node 105 via a communication link 700 after the sequences shown in FIGS. 6A and 6B are executed, forms a new link 701 with the IAB node 103, and connects thereto. The communication link 700 is disconnected and released, and the UE 119 is capable of communication using the eMBB slice type.

As described above, according to this embodiment, the IAB donor 101 determines (assigns) slice types for the IAB nodes 102 to 105 and informs the IAB nodes 102 to 105 of NSSAI, and thus can provide information regarding slice types appropriate to the UEs 110 to 119.

Note that, as described above, slice types are not limited to three types (eMBB, URLLC, MIot), and when an SST, which is a new slice type, is added, the above-described slice type determination method can also be applied using a predetermined condition. Furthermore, when an SD (Slice Differentiator), which is an option of SST, is used, it is also possible to apply the slice type determination method described above.

### Embodiment 2

In Embodiment 1, a method in which the IAB donor 101 assigns NSSAI to the IAB nodes 102 to 105 in the initial state when the communication system 100 starts operating, or in a static communication state is described. In Embodiment 2, a case will be described where a communication environment in the communication system 100 changes (e.g., a change in SNR, a change in the total number of connected UEs, and the like). Note that the description shared with Embodiment 1 is omitted.

In this embodiment, as a case where the communication environment changes, it is presumed that a communication state (communication quality) between the IAB donor 101 and the IAB node 103 deteriorates (e.g., SNR decreases) in the communication system 100. In this case, the IAB node 103 requests reassignment of NSSAI from the IAB donor 101. Alternatively, based on the received NSSAI, the IAB node 103 may judge that it is difficult (impossible) to maintain the network slice assigned to the IAB node 103, and may send, to the IAB donor 101, information “SST not maintainable” (information indicating that it is impossible to maintain the network slice). The IAB donor 101 can update and determine a slice supported by the IAB node 103 in response to the reception of such a request/information, and accordingly inform the IAB node 103 of the generated NSSAI.

Also, in a case where a communication environment changes as described above, the IAB node 103 may notify the UEs 113 to 115, and 119 of deterioration in the communication state for carrying out eMBB. In this case, the UEs 113 to 115, and 119 may further search for other IAB nodes 102, 104, and 105 that are connectable and support eMBB, and make a connection request in the case of good conditions.

As described above, according to this embodiment, the IAB donor 101 updates and determines (assigns) types of network slices that can be supported by an IAB node according to a change in the communication environment, and informs the IAB node of the NSSAI. Alternatively, the IAB donor notifies the UEs 110 to 119 of a deterioration in the communication state for carrying out a predetermined network slice, according to a change in the communication environment. As a result, the IAB node can provide the UEs 110 to 119 with information regarding appropriate slice types.

According to the present invention, it is possible to appropriately determine and transmit information regarding a network slice that can be supported by a node.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication device that functions as a base station in a communication network, the communication device comprising:
receiving unit configured to receive, from a node that relays communication between the communication device and a user equipment, first information regarding a path between the node and the communication device and second information regarding a status of the node;
determining unit configured to determine a type of network slice supported by the node, based on the first information and the second information; and
informing unit configured to inform the node of the determined type of network slice.

2. The communication device according to claim 1, wherein
the communication device is a communication device that functions as an IAB (Integrated Access and Backhaul) donor in an IAB network.

3. The communication device according to claim 1, wherein
the communication network includes an NR (New Radio) backhaul link and an NR access link.

4. The communication device according to claim 1, wherein
the informing unit informs the node of the one or more determined types of network slices, using a packet according to a BAP (Backhaul Adaptation Protocol) or an RRC (Radio Resource Control) protocol.

5. The communication device according to claim 1, further comprising
judging unit configured to judge a type of network slice supported by the communication device or another node that is directly connected to the node between the node and the communication device.

6. The communication device according to claim 5, wherein
the second information includes a value indicating a received signal quality of the node, and the total number of user equipments connected between the node and the communication device,
in a case where the judging unit judges that a high-speed and large-capacity communication is supported by the communication device or the other node as the type of network slice, and the value indicating the received signal quality is greater than or equal to a first specified value and the total number of user equipments is less than or equal to a second specified value, the determining unit determines that the high-speed and large-capacity communication is supported by the node.

7. The communication device according to claim 5, wherein
the first information includes the number of hops from the communication device to the node, and the second information includes information indicating whether or not the node supports TSN (Time-Sensitive Networking), and
in a case where the judging unit judges that a low latency communication is supported by the communication device or the other node as the type of network slice, and the node supports the TSN and the number of hops is greater than or equal to a third specified value, the determining unit determines that the low latency communication is supported by the node.

8. The communication device according to claim 1, wherein
the determining unit determines that a simultaneous multiple connection is supported by the node as the type of network slice.

9. The communication device according to claim 1, wherein
the receiving unit receives the first information and the second information at certain periodical timing.

10. The communication device according to claim 1, further comprising
requesting unit configured to request transmission of the first information and the second information from the node,
wherein the receiving unit receives the first information and the second information in response to the request made by the requesting unit.

11. The communication device according to claim 1, wherein
in a case where the informing unit informs the node of the determined type of network slice and information indicating that support for the determined network slice is not maintainable is then received by the receiving unit from the node, the determining unit updates and determines the type of network slice supported by the node.

12. A communication device that functions as a node that relays communication between a base station and a user equipment in a communication network, the communication device comprising:
transmitting unit configured to transmit, to the base station, first information regarding a path between the communication device and the base station and second information regarding a status of the communication device;
receiving unit configured to receive information regarding a type of network slice supported by the node, the type being determined by the base station based on the first information and the second information; and
notifying unit configured to notify the user equipment of information with which the communication device can be identified, together with the information regarding the type of network slice.

13. The communication device according to claim 12, wherein
the base station is a base station that functions as an IAB (Integrated Access and Backhaul) donor in an IAB network.

14. The communication device according to claim 12, wherein
the communication network includes an NR (New Radio) backhaul link and an NR access link.

15. The communication device according to claim 12, further comprising
judging unit configured to judge whether or not a network slice assigned according to the information received by the receiving unit is not maintainable, according to a change in a communication environment,
wherein in a case where the judging unit judges that the network slice is not maintainable, information indicating that support of the network slice is not maintainable is transmitted to the base station.

16. A method for controlling a communication device that functions as a base station in a communication network, the method comprising:
receiving, from a node that relays communication between the communication device and a user equipment, first information regarding a path between the node and the communication device and second information regarding a status of the node;
determining a type of network slice supported by the node, based on the first information and the second information; and
informing the node of the determined type of network slice.

17. A non-transitory computer-readable storage medium storing a program for causing a computer to execute a method for controlling a communication device that functions as a base station in a communication network, the method comprising:
receiving, from a node that relays communication between the communication device and a user equipment, first information regarding a path between the node and the communication device and second information regarding a status of the node;
determining a type of network slice supported by the node, based on the first information and the second information; and
informing the node of the determined type of network slice.
